(19) United States
(12) Patent Application Publication
(10) Pub. No.: US 2022/0253661 A1
(43) Pub. Date: Aug. 11, 2022

(54) METHOD FOR MANUFACTURING ELECTRONIC TRANSACTION CARDS

(71) Applicant: CREDIT CARD SUPPLIES CORPORATION, Marlborough, MA (US)

(72) Inventors: Patrick Daley, Marlborough, MA (US); Edmond Davis, Wake Forest, NC (US); Aaron Tucker, Cincinnati, OH (US)

(73) Assignee: CREDIT CARD SUPPLIES CORPORATION, Marlborough, MA (US)

(21) Appl. No.: 17/567,549

(22) Filed: Jan. 3, 2022

Related U.S. Application Data
(60) Provisional application No. 63/236,401, filed on Aug. 24, 2021.
(60) Provisional application No. 63/224,616, filed on Jul. 22, 2021.
(60) Provisional application No. 63/142,652, filed on Jan. 28, 2021.
(60) Provisional application No. 63/138,727, filed on Jan. 18, 2021.

(51) Int. Cl. G06K 19/077; B32B 15/08; B32B 37/14; B29C 64/393; B33Y 80/00; B33Y 50/02

(52) U.S. Cl. CPC G06K 19/07722; B32B 15/08; B32B 37/14; B32B 2425/00; B33Y 80/00; B33Y 50/02; B29C 64/393

(57) ABSTRACT

A method of providing a contactless card having a metal substrate with a first and second, a top and bottom face. A slit can be created in the creating a slit in the metal substrate wherein the slit has ends extending to the edges of the substrate. The method includes filling the slit with a central fill filler material wherein the central fill defines a top void between the central fill and a top plane relative to a top face of the substrate and the central fill defines a bottom void between the central fill and a bottom plane relative to a bottom face of the substrate. The filler material of the central, top, and bottom portions is cured and planned to be flush with the substrate front and back surfaces. The filler material can be a resin and the slit can have generally an “S” configuration or portion thereof.

### RELATED APPLICATION

This application claims priority on U.S. Provisional Patent Applications 63/132,957 filed Dec. 31, 2020; 63/138,727 filed Jan. 18, 2021; 63/142,652 filed Jan. 28, 2021; and 63/224,616 filed Jul. 22, 2021 and 63/236,401 filed Aug. 24, 2021 all of which are incorporated by reference.

### BACKGROUND OF THE INVENTION

### 1) Field of the Invention

The present invention is a method of providing a transaction card with the ability to transmit electronic information (e.g., credit card, financial instrument, identification card, security card, and the like including those with Europay, Mastercard and Visa chip—EMV chip) used to provide information about an account, the user or bearer, the card or other information including the ability to authenticate the account, user, bearer, card or associated an event or transactions card

### 2) Description of the Related Art

Most individuals and companies own or possess several different cards such as credit cards, debit cards, automatic teller machine (ATM) cards, employee identification cards, student identification cards, building access cards, club membership cards, airline frequent flyer cards, grocery store discount cards, department store account cards, telephone cards, rental cards, public transportation fare cards, and the like. To facilitate the operation and utility of these cards, one or more magnetic stripes can be used for storing data such as the bearer's identity or account information.

The magnetic stripe (e.g., mag stripe) or other magnetic area of the card typically stores digital data using magnetic based particles on a band of a magnetic material placed on the card. Typically, the magnetic stripe (e.g., swipe card or magstripe), can be read (e.g., data retrieve from the magnetic stripe) by swiping past a magnetic reading head or placing the magnetic stripe in proximity to a reader. As the technology has progressed, several International Organization for Standardization standards, ISO/IEC 7810, ISO/IEC 7811, ISO/IEC 7812, ISO/IEC 7813, ISO 8583, and ISO/IEC 4909, have provided definitions of the physical properties of the card, including size, flexibility, location of the magstripe, magnetic characteristics, and data formats. For example, U.S. Pat. No. 3,294,956 discloses a mechanism for positioning and referencing a magnetic ledger card so that information may be read from or written on to a magnetic stripe thereon by a movable magnetic head which traverses the ledger card.

A magnetic stripe can include magnetic particles suspended in a resin where the particles can be applied directly to the card or made into a stripe on a plastic backing which is applied to the card. The material used to make the particles defines the Coercivity (see below) of the stripe. Standard low coercivity stripes use iron oxide as the material to make the particles, high coercivity stripes are made from other materials like barium ferrite. These materials are mixed with a resin to form a uniform slurry which is then coated onto a substrate. In the case of a credit card or similar application the slurry is usually coated onto a wide plastic sheet and dried. The plastic sheet is then sliced into the stripe width and applied to the card during the card manufacturing process. The application of the stripe (e.g., cut sheet) includes lamination, hot-stamp, and cold-peel. All of these are a three-step application process and require making the sheet, making the stripe, and applying the stripe of the card. In another traditional method of applying magnetic material to a case, a magnetic slurry is painted on the card.

A significant disadvantage with the current technology in adding magnetic stripes to the card (e.g., substrate) is that the application of the magnetic stripe to a card can lead to error and premature wear and failures. Further, the amount of magnetic material that can be placed on a card is limited to the thickness of the applied stripe. It is undesirable for the magnetic stripe to cause a ridge or to be raised too much above the card substrate as this disadvantage prevents the face of the card from being planer. Further, it is shown that if the magnetic stripe is exposed to a magnetic field, the information on the magnetic stripe can be damaged and even erased. In one study, it was discovered that if a D82 magnet was rubbed against a traditional credit card at a distance of 0.02 inches or less, the magnetic stripe ceased functioning. It would be advantageous to have a magnetic stripe that can be read by a reader while having a separation from the outer most surface of the card.

Cards, including cards, have evolved from credit cards and other cards having raised alphanumeric characters built included on the card into cards having embedded chips, EMV chip and other electronics. Typically, a card has the footprint of a credit card. The housing of the card typically includes electronics that can store information thereby making the card “smart” in that it can store its data and applications. Some cards have basic data processing functionality by adding processors.

Cards can store personal information, store digital currency, verify identity and any combination thereof. Cards have advanced from cards that only include raised characters, magnetic strips or barcodes that rely on the card processing of other networks to function.

Consumers have shown that metal financial cards are desirable both in the look and feel of the card. Metal cards, with added weight and the sounds when contacting a surface, have become a symbol of status and seem to be more attractive to consumers that desire leading edge technologies. There is also a perception that a metal card represents a higher quality, credit card issuer. Further, financial institutions are consistently seeking new solutions for customer as well as points of differentiation with their competitors. Offering metal cards with these financial institutions brand is one vehicle used by these financial institutions. As stated, the current production of metal cards creates challenges and can be a complicated process. For example, U.S. Pat. No. 7,530,491 shown a card that include a core layer that is thermoplastic material which could include PVC, PET copolymer, or other substrate. There is then a metal laminated to one or both sides of the core layer. The card includes a pocket that can be filled with a panel. The fill panel be adhered to the pocket. This this patent described a metal card, it does not provide for a method of removing the inefficiencies of information transmission (e.g., wireless transmission) as the fill panel is made using the method of the card which includes a metal layer throughout.

Therefore, it is an object of the present invention to provide for a metal or mostly metal financial card that allows for contactless payment.

It is another object of the present invention to provide for a metal card having contactless payment using EMV chips.

### BRIEF SUMMARY OF THE INVENTION

The above objectives are accomplished by providing a method of providing a contactless card comprising a substrate; creating a slit, that, in one embodiment, can be at least 250μ in thickness into a substrate. The slit can be useful to counteract the shielding created when a conductive substrate is present. The slit can redefine the flow of electrons in, what is effectively a Faraday cage, created by a conductive substrate. The slit can reduce or prevent the substrate from interfering with the EMV chip and allow the conductive material to act as an antenna. The reconfiguring and/or redirecting of electrons can occur when using a number of substrate materials including brass, silver, gold, aluminum, molybdenum, titanium, tungsten, other metals, and any combination. The slit can be filled with a malleable filler material. The filler material can be a polymer, ceramic, composite, plastic, and any combination. The substrate and the filler material can be coated or painted. The method can include attaching a chip to the substrate. The coating or painting can be color, metallic or both. The method can strengthen the slitted area and substrate by using the filler material.

The filling of the slitted area can be force cured at a higher temperature than the temperature where filling occurs. This filling process can be performed multiple times so that the filler material, in the event of shrinkage, completely fills the slit and results in a planar surface. Repeating the filling and curing process assists with a complete fill of the slit and can assist with providing a flush and level surface defined by the substrate and filled slit. The slit can be cut into the substrate at a depth of 20μ or less in one embodiment. A chip can be inserted in the substrate. Testing can be performed to determine if the card can be read by a reader.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a diagram of aspects of a card;

FIG. 2A is a diagram of aspects of a card;

FIG. 2B is a diagram of aspects of a card;

FIG. 3A is a perspective view of aspects of a card;

FIG. 3B is an edge view of aspects of a card;

FIG. 3C is an edge view of aspects of a card;

FIG. 4 is a flowchart of aspects of the manufacturing process;

FIG. 5A is an edge view of aspects of a card;

FIG. 5B is an edge view of aspects of a card;

FIG. 6A is an edge view of aspects of a card;

FIG. 6B is an edge view of aspects of a card;

FIG. 7A is an edge view of aspects of a card;

FIG. 7B is a perspective view of aspects of a card;

FIG. 7C is an edge view of aspects of a card;

FIG. 7D is a front view of aspects of a card;

FIG. 8A is a top view of aspects of a card;

FIG. 8B is a top view of aspects of a card;

FIG. 8C is a side view of aspects of a card;

FIG. 9A is a side view of aspects of a card,

FIG. 9B is a side view of aspects of a card,

FIG. 10A is a side view of aspects of a card,

FIG. 10B is a side view of aspects of a card,

FIG. 10C is a side view of aspects of a card, and,

FIG. 10D is a side view of aspects of a card.

### DETAILED DESCRIPTION OF THE INVENTION

With reference to the drawings, the invention will now be described in more detail.

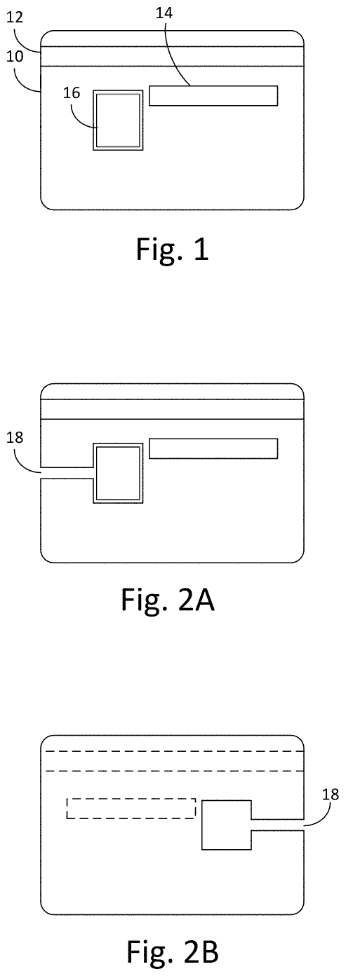

Referring to FIG. 1, a card 10 is shown including a magnetic strip 12, signature block 14 and chip 16. For a contactless card to operate, information must be transmitted from the chip to a reader. For a contactless card to operate regardless of orientation, information from the chip needs to be read from the front of the card as shown in FIG. 1 and the back of the card as shown in FIG. 1. In its manufacturing, the process can begin with a substrate which can be a layer of the completed card. An antenna connected to the chip is needed for transmission of data from the chip to a reader without the chip contacting the reader. When the card includes a metal layer or other component that prevents electrical transmission the chip is unable to transmit information to the reader.

Referring to FIGS. 2A (back in one embodiment) and 2B (front in one embodiment), the card can include a slit 18 where the antenna can be disposed thereby exposing the antenna to a reader allowing transmission of information from the chip to a reader. An insulating substrate or other layer can be used while also allowing for contactless transmission of data. Once the slit is made into the substrate, the substrate will no longer interfere with the signal of the EMV chip to provide for a contactless transaction. The slit can be filled in a manner so that the surface of the card and the filled slit is smooth. In one embodiment, the surface of the substrate and the surface of the slit have a variance in thickness of less than 20μ and can be less than 10μ. In some embodiment where contactless functionality can be provided, the slit (or void) placed in the card cannot be filled with a material that is conductive (e.g., the filler material is non-conductive).

The non-conductive filler material can be applied in, on, or over the card and its slit. The filler material can be dielectric. The process of providing the filler material can include processing or treating a portion of or the entire card using an injection machine, manual application, additive manufacturing, phase change application, of both. The process of providing the filler material can include rolling, spraying, printing, spreading, or self-leveling the filler material into the slit. The filler material, once applied to the card and inserted into the slit, can be cured at a temperature at least one-degree Fahrenheit more than the application temperature. The filler material can then be force cured. The process of applying filler material can be through multiple applications. The filler material can be cured by forced air or heat which can strengthen the filler material as well as bond the filler material to the substrate creating a solid composite. The composite can receive printing or can be coated with paint or other coating. Application of a coating or paint can include curing the coating or paint to obscure the filled slit.

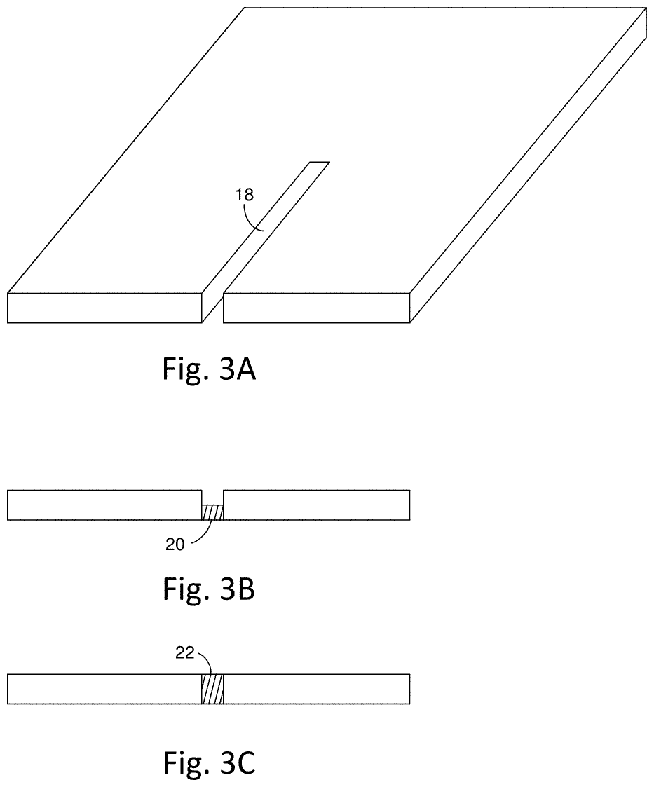

Referring to FIGS. 3A through 3C, the slit 18 can be manufactured into the card by cutting or included when the substrate is first made. The slit can extend into the substrate, or other layer, partially or completely. The filler material can be placed on the slit in phases so that a first portion of filler material 20 can be placed in the slit and cured. This method provides for the metal substrate to transfer from an undesirable electrically interfering substrate to where a portion or even the entire substrate acts as an antenna. A second portion of filler material 22 can then be added to complete the filling of the slit. The card can then be smoothed so that the front face and the rear face are planer.

The coating or paint that can be applied over the filled slit and surrounding area can be on a single or multi-phase process. The application of the coating or paint can involve a vacuum or physical vapor deposition which provide for an aesthetic appearance of metal or metallization. The filling of the slit and application of the coating and the paint can strengthen the substrate and card. The filled slit with a coating or paint allows for an atheistically smooth surface while also allowing the transmission of data from the card chip to a reader to be successful even when an insulating substrate or layer (e.g., metal substrate) is used.

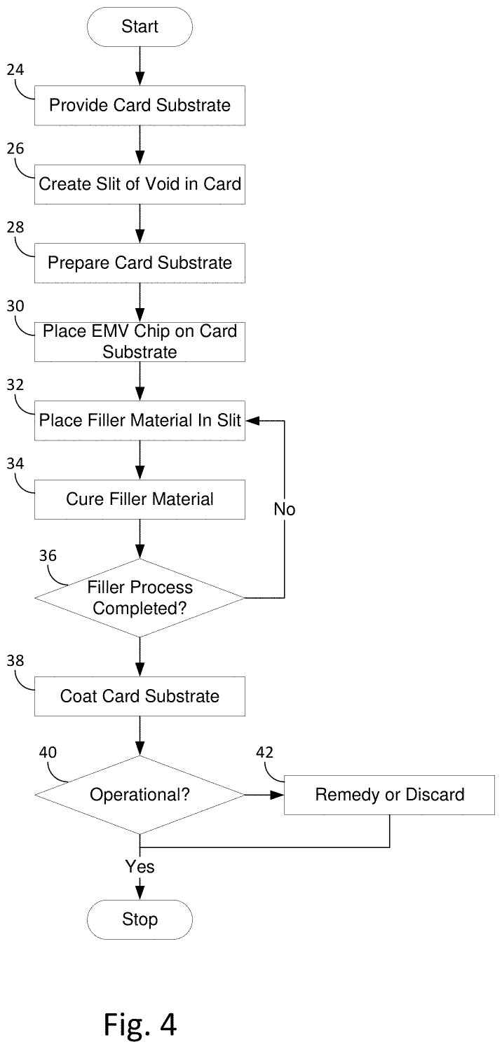

Referring to FIG. 4, the manufacturing process can begin with providing a substrate or one layer of a card at 24. A slit or void can be included in the card at 26. The card can be prepared for receipt of a chip, processor, controller, antenna, or other component at 28. For example, the substrate can have a recess placed on the substrate for receiving a chip. The chip and other components can then be received by the card and the recess placed on the card at 30. Filler material can be placed into the slit at 32. The filler material can be cured at 34. The filling process can include multiple steps or multiple applications so that if further steps are needed at 36, the process can return to 32 or other processing step to complete the card. Once the filing process is completed, the card can be coated or painted at 38. The card can be tested at 40 to determine if it is operational and if so, the process completes. If the card is not operational, the card can be corrected or discarded at 42.

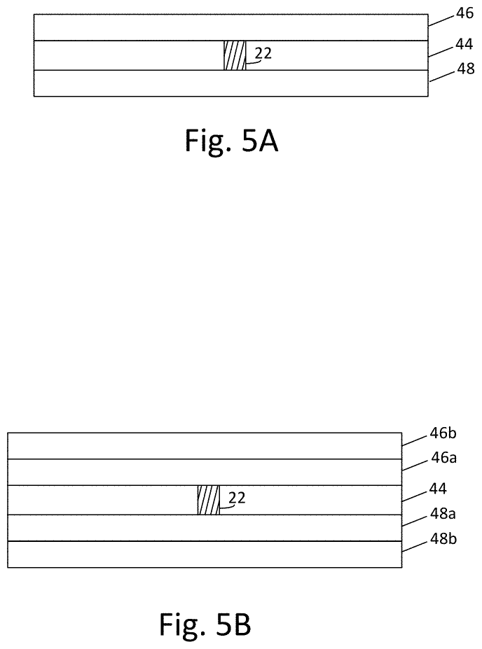

Referring to FIG. 5A, the substrate with filler 44 can have one or more upper layers 46 and one or more lower layers 48 applied to the substrate. The upper layer and the lower layer can be taken from the group consisting of an insulation layer, buffer, PET, PVC, copolymer, laminate, paint, layer applied using methods such as physical vapor deposition, and any combination thereof. The layers can be opaque, transparent, holographic, polarized, semi-transparent and any combination thereof. In one embodiment, multiple layers are disposed on each side of the substrate with the layer mirroring each other as shown in FIG. 5B. In this configuration the substrate 44 can carry a first upper layer 46a and a second upper layer 46b where the first and the second layer are taken from the group consisting of an insulation layer, buffer, PET, PVC, copolymer, laminate, paint, layer applied using methods such as physical vapor deposition, and any combination thereof. A first lower layer 48a and a second lower layer 48b can be carried by the substrate where the first and the second lower layers are taken from the group consisting of an insulation layer, buffer, PET, PVC, laminate, paint, film, layer applied using methods such as physical vapor deposition, and any combination thereof. The first upper layer 46a can be made from the same material as the first lower layer 48a. The second upper layer 46b can be made from the same material as the second lower layer 48b. An antenna assembly can be disposed in the first upper layer, between the first upper layer and the second upper layer, in the second upper layer, on the second upper layer and any combination thereof. An antenna assembly can be disposed in the first lower layer, between the first lower layer and the second lower layer, in the second lower layer, on the second lower layer, and any combination thereof. The first layer upper layer and the first lower layer need not be adjacent to the substrate. An antenna assembly can be disposed between or included in one of the layers. Filler material 22 can be planer with the substrate prior to the application of one or more layers.

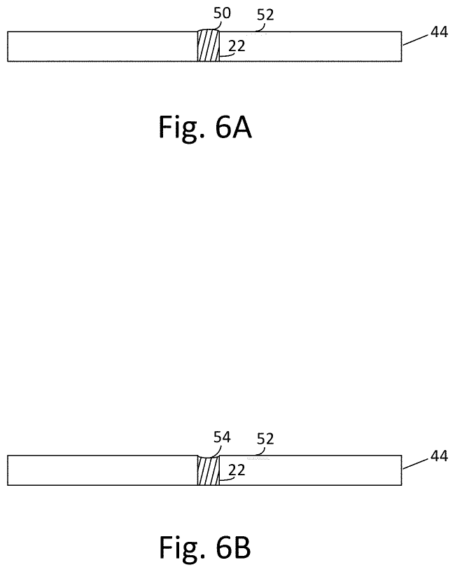

Referring to FIGS. 6A and 6B, the filler material can have a concave or convex edge relative to the substrate that is in the range of −5.00 μm to +5.00 μm. In one embodiment, the filler material forms a convex surface 50. The peak of the convex surface can be in the range of 0.00 μm to 10.00 μm relative to the surface 52 of the substrate an in one embedment between 0.00 μm to 5.00 μm. When the filler material is generally planer with the surface of the substrate, the undesirable discontinuity of the planer transition across the substrate surface and the filler material is reduced or eliminated. In one embodiment, the filler material forms a concave surface 54. The trough of the concave surface can be in the range of 0.00 μm to −10.00 μm relative to the surface 52 of the substrate an in one embedment between 0.00 μm to −5.00 μm. When the filler material is generally planer with the surface of the substrate, the undesirable discontinuity of the planer transition across the substrate surface and the filler material is reduced or eliminated.

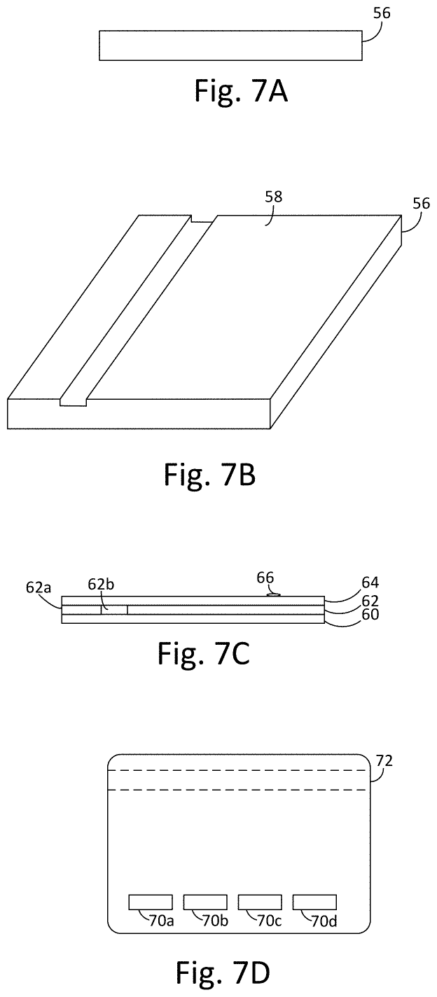

Referring to FIGS. 7A through 7C, a substrate 56 is shown which is used to receive printing, one or more layers and magnetic material. The substrate can have a slot 58 that can be cut into the substrate or manufactured into the substrate when the substrate is created. The depth of the slot can be deeper than the thickness of a traditional magnetic stripe that is made from a sheet of film. The slot can then be filled with a magnetic material that can be added to the slot using additive manufacturing. The magnetic material can include magnetic particles that are included in the material which is applied using additive manufacturing. The magnetic material can include a polymer with magnetic particles mixed in with the polymer so that when the additive manufacturing process is used to apply the magnetic material to the substrate, a magnetic stripe is formed.

In one embodiment, the additive manufacturing process can include the application of two material to form the substrate with a magnetic stripe or magnetic area. The additive manufacturing process can include a first set of passes where substrate material is added and a first portion 60 of the substrate is created. The additive manufacturing process can be used to create a second portion 62 that can have substrate material 62a and magnetic material 62b deposited on the first portion of the substrate 60. The magnetic material can include magnetic particles configured to allowing recording of information in a range of 25 to 500 bits per inch. There can be one or more stripes placed on the substrate. The substrate, with magnetic material can be coated and painted in one embodiment.

In one embodiment, a third portion 64 can be manufactured through additive manufacturing that can include adding indicia 66 such as alpha numeric characters, figures, shapes, images, and any combination to the substrate. For example, the additive manufacturing process can cause an account number to be placed on the substrate in raised numbers or the substrate can be created with material absent so that the absence of material causes numbers to appear debossed or imbedded into the substrate. The indicia can be an account number that can be separate din more or more groupings 70a through 70d. The magnetic portion 72 made with additive manufacturing place placing the magnetic material during or after the substrate is made can be on one side of the substrate with the indicia manufactured on the other side of the substrate. The indicia can be a custom image of graphic that is supplied by a user and can allow each card to be customized by the user.

In one embodiment, the concave or convex surface of the filler material is not perceivable to the human touch and provides for an aesthetic appearance and feeling. The multiple filling and curing steps allow for the filler material to be generally planer with the surface of the substrate an account for expansion and shrinkage of the filler material during the manufacturing process.

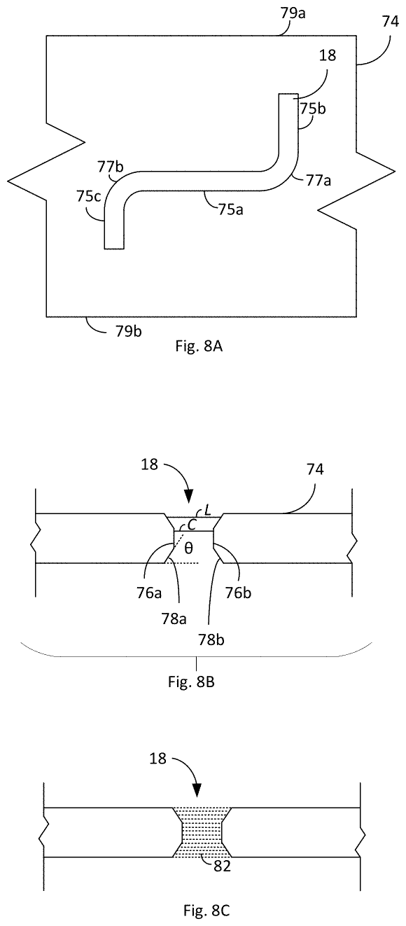

Referring to FIG. 8A, a plate 74 that can be used for the manufacturer of cards so that the slit 18 is included in the card. The card can be stamped from metal and the antenna configured to be disposed on the slit. The slit can include a central section 75a. In one embodiment, the central section can generally run the length of the substrate. The slit can include a first end 75b that include a first turn 77a and extends generally to a first edge 79a of the substrate. The slit can include a second end 75c that include a second turn 77b and extends generally to a second edge 79b of the substrate. The slit can be in generally an “S” configuration, accordion configuration, spiral configuration including a circular, square, triangular, rectangular, or asymmetric spiral configuration, and any combination. The slit can be position central to the substrate of offset from the center of the substrate. The slit can be continuous with a chip area adapted for receiving a chip.

Referring to FIG. 8B, a horizontal cross-section is shown having the plate 74 and the slit 18. The slit can include lateral walls 76a and 76b. The slit can also include support walls such as 78a and 78b. The angle θ between the support wall and a horizontal edge 80 of the plate or card can be in the range of 100.0 degrees to 170.0 degrees. In one embodiment, the angle θ is 135.0 degrees. The distance between the central area of the slit can be of a smaller distance that that of the distance between the lateral walls. For example, if the central distance is C and the distance between the lateral wall is L, C<L.

Referring to FIG. 8C, the slit 18 can be filled with a resin 82. The resin can be a bi-component adhesive that can be epoxy based in on embodiment. The resin can include a component taken from the group consisting of polyamidoamine, amines, polyethylenepoly-, tetraethylenepentamine fraction, 2,4,6-tris (dimethylaminomethyl) phenol, 3-aminopropyltriethoxysilane and any combination thereof. The resin can include polyamidoamine in the range of 25% to 75%. The resin can include amines, polyethylenepoly-, tetraethylenepentamine fraction in the range of 0.5% to 10%. The resin can include 2,4,6-tris (dimethylaminomethyl) phenol in the range of 0.5% to 10%. The resin can include 3-aminopropyltriethoxysilane in the range of 0.5% to 10%. The resin can have a medium viscosity greater than about 50,000 mPa s at room temperature.

The resin can include the reaction product of Bisphenol A and epichlorhydrine (having an average molecular weight <700) and can be greater than 50% of the resin. The resin can include neodecanoic acid, 2,3-epoxypropyl ester and be in the range of 0.5% to 10% of the resin. The filler material can include the resin and a ferromagnetic material added to the material to provide for a ferromagnetic resin that can be added to the slit.

The resin can be applied in one process, allowed to cure, or partially cure and an additional resin applied in a second process. When cured to dry, the resin is flush with the horizontal edge of the card or plate. When painted, the card or plate appears flat and of a single material rather than metal with resin.

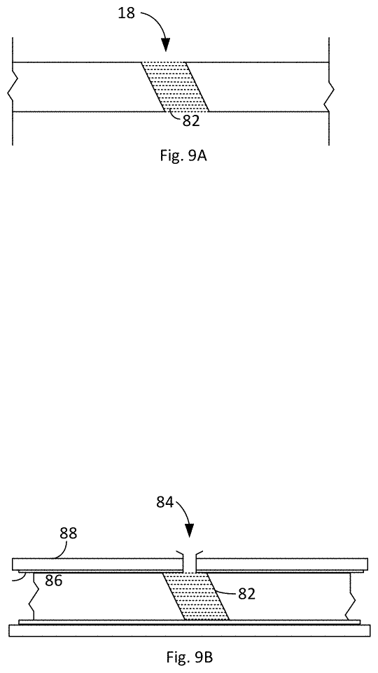

Referring to FIGS. 9A and 9B, the slit can include diagonal walls relative to the edges of the card. The walls can have an angel between 50 degrees and 85 degrees relative to a horizontal plane. The resins of binding agent can be injected through an injection port 84 that can include a valve to allow resin of a binding agent to enter the slit. Once a pre-determined volume of resin or binding agent is injected into the slit in the substrate, the valve can be closed. A nonstick layer 86 material such as ceramic, silicone, enamel, polytetrafluoroethylene or other nonstick or hydrophobic material can be placed on the substrate or on a pressure plate. The nonstick layer can be adjacent to one or both side of the substrate. A pressures plate 88 can then apply pressures and/or heat to the side of the substrate configured to cure the resin or binding agent, dissipate excess resin or binding agent across the side of the substrate to provide a smooth surface, smooth the resin or binding agent and any combination. The pressure plate can be included in a manual or hydraulic press and be included in the manufacturing process of a financial card. The substrate and resin or binding agent can be removed from the press and additional layers can be added to the substrate such as a protective layer, paint layer, transparent layer, glass layer, polymer layer, security overlay, metal layer, adhesive, ink layer, printer layer, and any combination. The substrate can include material taken from the group consisting of paint, security overlay, UV print, personalization layer, glass, polymer, metal, adhesive, ink, and any combination.

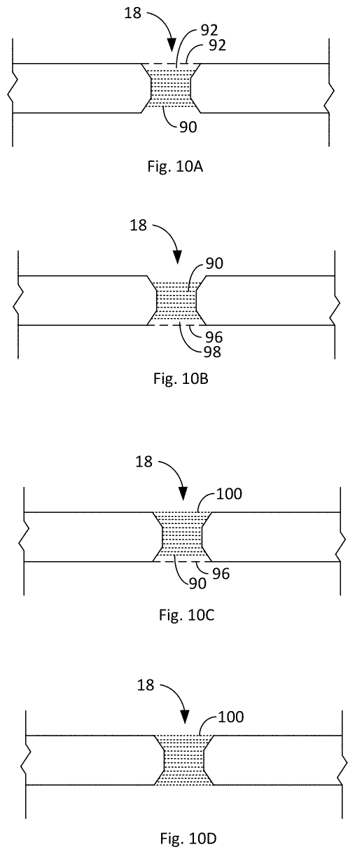

Referring to FIG. 10A, the slit 18 can initially be filled with filler material producing a first fill 90 that which does not completely fill the slit to a top plane 92 parallel to a top face of the substrate defining a top void 94. Referring to FIG. 10B, the filler material of the first fill need not completely fill the slit to a bottom plane 96 parallel to a lower face of the substrate defining a lower void 98. In the embodiment, the first fill results in a central fill layer in the substrate. The central fill layer can comprise a difference material than the top fill filler material and the bottom fill filler material. Referring to FIG. 10C, a top fill can be applied to the top void and cured. Referring to FIG. 10D, a bottom fill can be applied to the bottom void and cured. In this embodiment, the swelling or the shrinkage of the fill be reduced as the top void and the bottom void as these voids are each of a smaller area than the entire slit itself. If the top filler is not flush with the top plane, the top filler can be planed, sanded, brushed, or otherwise physically modified so that the top filler is flush with the top plane. If the bottom filler is not flush with the bottom plane, the bottom filler can be planed, sanded, brushed, or otherwise physically modified so that the bottom filler is flush with the bottom plane. The first fill, top fill and bottom fill can be of the same or difference material and can be deposited in the slit using additive manufacturing,

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A method of providing a contactless card comprising:
providing a metal substrate having a first edge, a top face, a second edge, and a bottom face;
creating a slit in the metal substrate wherein the slit has a first end extending to the first edge and a second end extending to the second edge;
filling the slit with a central fill filler material wherein the central fill defines a top void between the central fill and a top plane relative to the top face of the metal substrate and the central fill defines a bottom void between the central fill and a bottom plane relative to the bottom face of the metal substrate,
curing the central fill filler material,
adding a top filler material to the top void defining a top fill, and,
curing the top filler material.

2. The method of claim 1 including planning the top filler material so that a top fill is flush with a the top face of the metal substrate.

3. The method of claim 1 including adding a bottom filler material to the bottom void and curing the bottom filler material to define a bottom fill.

4. The method of claim 3 including planning the bottom filler material so that the bottom fill is flush with the bottom face of the metal substrate.

5. The method of claim 1 including adding a paint layer to the metal substrate.

6. The method of claim 1 including adding a coating to the metal substrate.

7. The method of claim 1 including affixing a chip to the metal substrate adapted to emit electronic information through at least one of the central filler material and the top filler material.

8. The method of claim 1 wherein the slit includes a central distance that is less than a lateral wall distance.

9. The method of claim 1 wherein adding the central filler material is accomplished with additive manufacturing.

10. A method of providing a contactless card comprising:
providing a metal substrate;
creating a slit in the metal substrate;
filling the slit with a central filler material and curing the central filler material,
adding a top filler material to a top void wherein the top void is defined between the central filler material and a top plane parallel to a top face of the metal substrate, and,
curing the top filler material.

11. The method of claim 10 including adding a bottom filler material to a bottom void defined between the central filler material and a bottom plane parallel to a bottom face of the metal substrate, and,
curing the bottom filler material.

12. The method of claim 10 wherein the slit, the central filler material, and the top filler material are adapted to distribute electromagnetic signals from a chip affixed to the metal substrate to an area external to the metal substrate.

13. The method of claim 10 wherein the central filler material is cured with a forced cure.

14. The method of claim 10 including providing a coating the metal substrate and the top filler material.

15. The method of claim 10 including etching information into the metal substrate.

16. The method of claim 10 wherein the top filler material extends above the top plane in a range of 0.00 μm to 5.00 μm.

17. The method of claim 10 wherein the central filler material is a resin.

18. A method of providing a contactless card comprising:
providing a metal substrate having a top face and a bottom face;
creating a slit having a central section and an end wherein the end is non-parallel to the central section.
filling the slit with a filler material
curing the filler material, and,
planning the filler material to be flush with the top face and the bottom face of the metal substrate.

19. The method of claim 18 wherein the end is a first end extending to a first edge of the metal substrate and a second end included in the slit extending to a second edge of the metal substrate.

20. The method of claim 19 where in the slit is in a “S” shape.
